(19) United States
(12) Patent Application Publication
(10) Pub. No.: US 2014/0024491 A1
(43) Pub. Date: Jan. 23, 2014

(54) HYBRID VEHICLE

(71) Applicants: Shunya KOBAYASHI, Toyota-shi (JP); Shinichi SUGAI, Toyota-shi (JP); Tomoyuki SHIBATA, Toyota-shi (JP)

(72) Inventors: Shunya KOBAYASHI, Toyota-shi (JP); Shinichi SUGAI, Toyota-shi (JP); Tomoyuki SHIBATA, Toyota-shi (JP)

(73) Assignee: TOYOTA JIDOSHA KABUSHIKI KAISHA, Toyota-shi (JP)

(21) Appl. No.: 13/940,389

(22) Filed: Jul. 12, 2013

(30) Foreign Application Priority Data
Jul. 20, 2012 (JP) 2012-161431

(51) Int. Cl. B60W 20/00

(52) U.S. Cl. CPC B60W 20/10; Y10S 903/93
USPC 477/3; 180/65.265; 903/930

(57) ABSTRACT

A hybrid vehicle includes an engine that is mounted on a vehicle body via an engine mount, and outputs power to a drive shaft coupled to an axle; a motor that outputs power to the drive shaft; a battery that supplies electric power to the motor; and a control unit configured to start the engine when a torque of the drive shaft becomes equal to or larger than a start threshold value while the vehicle travels with the engine stopped, the start threshold value being set such that the start threshold value is equal to or smaller than a rated corresponding torque and a difference between the start threshold value and the rated corresponding torque tends to increase as a rotational speed of the drive shaft decreases, and the rated corresponding torque being a torque of the drive shaft corresponding to a rated maximum torque of the motor.

### INCORPORATION BY REFERENCE

The disclosure of Japanese Patent Application No. 2012-161431 filed on Jul. 20, 2012 including the specification, drawings and abstract is incorporated herein by reference in its entirety.

### BACKGROUND OF THE INVENTION

1. Field of the Invention

The invention relates to a hybrid vehicle.

2. Description of Related Art

Conventionally, as this kind of hybrid vehicle, there have been proposed hybrid vehicles each of which includes an engine that is supported on an engine mount, a motor-generator that is coupled to the engine, a transmission that is coupled to the motor-generator and a drive shaft, and an electric storage device that is electrically connected to the motor-generator via an inverter. In each of these hybrid vehicles, in starting the engine, the engine is controlled such that the initial combustion torque decreases as the roll angle immediately before the initial combustion of the engine increases toward the negative side (as the restoring force of the engine mount increases toward the positive side) (e.g., see Japanese Patent Application Publication No. 2009-203816 (JP-2009-203816 A)). In each of these hybrid vehicles, due to this control, the engine can be restrained from vibrating regardless of the displacement of the engine (the roll angle) before the initial combustion.

In such a hybrid vehicle, if a large torque is output to the drive shaft when the vehicle travels with the engine stopped, the reaction force applied to the engine mount via the engine increases, and as a result, an elastic body may be compressed in the engine mount. Besides, in general, the rated maximum torque of the motor-generator tends to increase as the rotational speed of the motor-generator decreases. Accordingly, if a value that is obtained by converting the rated maximum torque of the motor-generator into a torque of the drive shaft is set as an engine start threshold value, and the engine is started as soon as the torque of the drive shaft becomes equal to or larger than this start threshold value, the engine may be started with the elastic body being compressed in the engine mount, when the rotational speed of the drive shaft is low. In this case, vibrations caused in starting the engine are likely to be transmitted to a vehicle body, and as a result, a great shock is likely to be caused.

### SUMMARY OF THE INVENTION

A hybrid vehicle according to the invention restrains a great shock from being caused in starting an engine.

An aspect of the invention relates to a hybrid vehicle including an engine that is mounted on a vehicle body via an engine mount, and outputs power to a drive shaft that is coupled to an axle; a motor that outputs power to the drive shaft; a battery that supplies electric power to the motor; and a control unit configured to start the engine when a torque of the drive shaft becomes equal to or larger than a start threshold value while the vehicle travels with the engine stopped. The start threshold value is set such that the start threshold value is equal to or smaller than a rated corresponding torque and a difference between the start threshold value and the rated corresponding torque tends to increase as a rotational speed of the drive shaft decreases. The rated corresponding torque is a torque of the drive shaft corresponding to a rated maximum torque of the motor.

In this hybrid vehicle according to the foregoing aspect of the invention, the engine is started when the torque of the drive shaft becomes equal to or larger than the start threshold value while the vehicle travels with the engine stopped, and the start threshold value is set such that the start threshold value is equal to or smaller than a rated corresponding torque and a difference between the start threshold value and the rated corresponding torque tends to increase as a rotational speed of the drive shaft decreases. The rated corresponding torque is a torque of the drive shaft corresponding to a rated maximum torque of the motor. Thus, the engine can be restrained from being started with the torque of the drive shaft being relatively large (with an elastic body being compressed in the engine mount), and hence, the occurrence of a great shock can be suppressed in starting the engine. It should be noted herein that “the rated corresponding torque” is equal to a torque corresponding to the rated maximum torque of the motor and the speed reduction ratio of a speed reducer or the speed ratio of a transmission if the motor is connected to the drive shaft via the speed reducer or the transmission, and that “the rated corresponding torque” is equal to the rated maximum torque of the motor if the motor is directly connected to the drive shaft.

In the hybrid vehicle according to the foregoing aspect of the invention, the start threshold value may be set such that the engine is started with a displacement amount of the engine mount being smaller than a predetermined displacement amount. It should be noted herein that “the predetermined displacement amount” can also be defined as a displacement amount at which the elastic body is compressed in the engine mount. In the hybrid vehicle according to the foregoing aspect of the invention in which the engine is started when the torque of the drive shaft becomes equal to or larger than the start threshold value, the torque of the drive shaft is considered to increase during the start of the engine in many cases (i.e., during the process of starting the engine). Therefore, the configuration may be such that the displacement amount of the engine mount does not reach the predetermined displacement amount until the start of the engine is completed (i.e., until the process of starting the engine is completed). Accordingly, the start threshold value may be set smaller than a value that is obtained by subtracting an increase (an assumed value) in the torque of the drive shaft during the start of the engine (i.e., during the process of starting the engine) from the torque of the drive shaft at which the elastic body is compressed in the engine mount.

In the hybrid vehicle according to the foregoing aspect of the invention, the start threshold value may be set in accordance with at least one of a shift position, a traveling mode, a temperature of the engine mount, a road surface gradient, and an acceleration. It should be noted herein that a forward traveling position and a backward traveling position may be regarded as “the shift position”. Besides, a normal traveling mode, an economy mode in which higher priority is given to fuel economy than in the normal traveling mode, an EV mode in which higher priority is given to traveling in a motor operation mode than in the normal traveling mode, a sport mode in which higher priority is given to acceleration than in the normal traveling mode, a power mode in which higher priority is given to torque (power) output than in the normal traveling mode, and the like may be regarded as “the traveling mode”.

The hybrid vehicle according to the foregoing aspect of the invention may further include an electric generator that exchanges electric power with the battery, and a planetary gear that has three rotating components connected to the drive shaft, an output shaft of the engine, and a rotation shaft of the electric generator.

The hybrid vehicle according to the foregoing aspect of the invention may further include a second motor that exchanges electric power with the battery, and that outputs power to a second drive shaft coupled to a second axle that is different from the axle, the start threshold value being set without taking a torque of the second drive shaft into account. This is because the torque of the second drive shaft is considered to have a sufficiently smaller influence on the displacement of the engine mount than the torque of the drive shaft.

### BRIEF DESCRIPTION OF THE DRAWINGS

Features, advantages, and technical and industrial significance of an exemplary embodiment of the invention will be described below with reference to the accompanying drawings, in which like numerals denote like elements, and wherein:

FIG. 1 is a configuration diagram showing the outline of the configuration of a hybrid vehicle as one embodiment of the invention;

FIGS. 2A and 2B show a flowchart showing an example of a drive control routine that is executed by an HVECU of the embodiment of the invention;

FIG. 3 is an illustration diagram showing an example of a required torque setting map;

FIG. 4 is an illustration diagram showing an example of a relationship between a drive shaft torque applied to a ring gear shaft as a drive shaft and a displacement amount of an engine mount;

FIG. 5 is an illustration diagram showing an example of a relationship between a rotational speed of a motor and a rated maximum torque;

FIG. 6 is an illustration diagram showing an example of a relationship among a rated corresponding torque, an elastic body compression torque, and a start threshold value;

FIG. 7 is an illustration diagram showing an example of a collinear diagram showing a mechanical relationship between rotational speed and torque in rotating components of a planetary gear when starting an engine;

FIG. 8 is an illustration diagram showing an example of an operating line of the engine and how a target rotational speed and a target torque are set;

FIG. 9 is an illustration diagram showing an example of a collinear diagram showing a mechanical relationship between rotational speed and torque in the rotating components of the planetary gear while the hybrid vehicle travels with power output from the engine;

FIG. 10 is an illustration diagram showing an example of the manner in which the required torque, the rate value, the displacement amount of the engine mount, the shock, and the output of the engine change with time in starting the engine when the rotational speed of the ring gear shaft is relatively small (when the rated corresponding torque is relatively large);

FIG. 11 is a block diagram showing the outline of the configuration of a hybrid vehicle according to a modification example; and

FIG. 12 is a block diagram showing the outline of the configuration of a hybrid vehicle according to another modification example.

### DETAILED DESCRIPTION OF EMBODIMENT

An embodiment of the invention will be described.

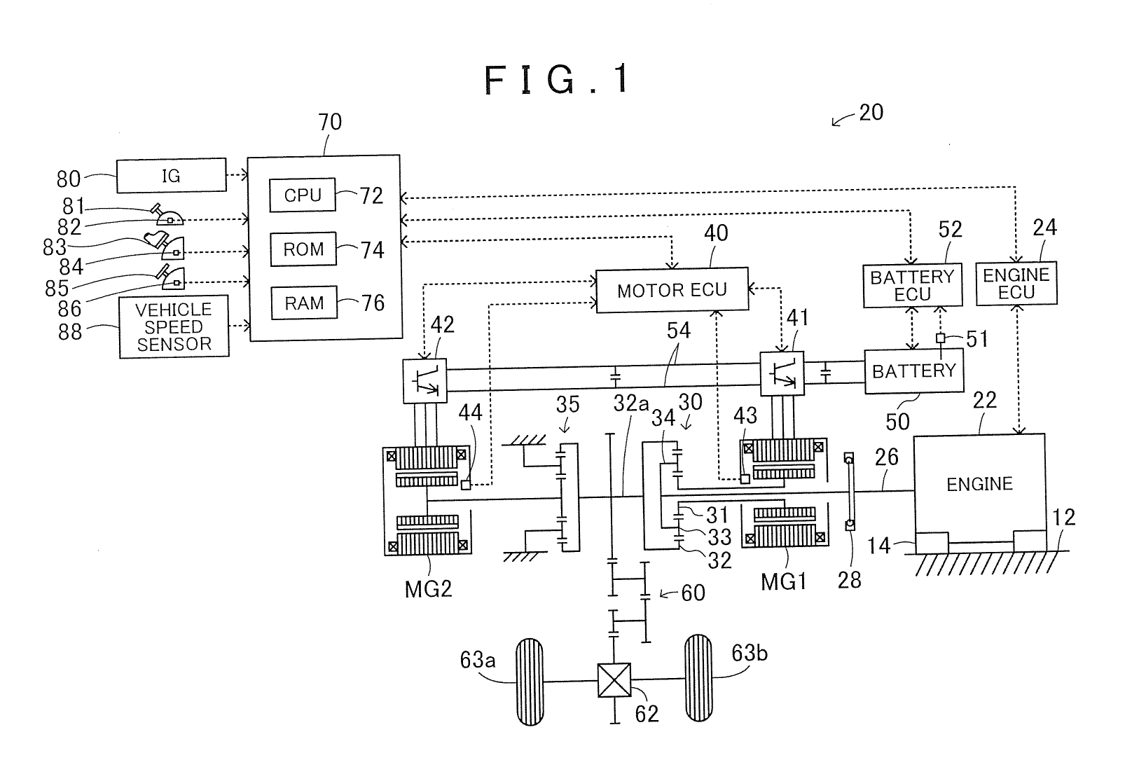

FIG. 1 is a configuration diagram showing the outline of the configuration of the hybrid vehicle 20 as an embodiment of the invention. As shown in FIG. 1, the hybrid vehicle 20 according to the embodiment of the invention includes an engine 22, an engine electronic control unit (hereinafter referred to as an engine ECU) 24, a planetary gear 30, a motor MG1, a motor MG2, inverters 41 and 42, a motor electronic control unit (hereinafter referred to as a motor ECU) 40, a battery 50, a battery electronic control unit (hereinafter referred to as a battery ECU) 52, and the hybrid electronic control unit (hereinafter referred to as the HVECU) 70. The engine 22 outputs motive power using gasoline, light oil, or the like as fuel. The engine ECU 24 performs drive control for the engine 22. The planetary gear 30 is configured such that a carrier 34 to which a plurality of pinion gears 33 are coupled is connected to a crankshaft 26 as an output shaft of the engine 22 via a damper 28, and that a ring gear 32 is connected to the ring gear shaft 32a as a drive shaft that is coupled to driving wheels 63a and 63b via a differential gear 62 and a gear mechanism 60. The motor MG1 is configured as, for example, a well-known synchronous generator motor, and has a rotor connected to a sun gear 31 of the planetary gear 30. The motor MG2 is configured as, for example, a well-known synchronous generator motor, and has a rotor connected to the ring gear shaft 32a as the drive shaft via a reduction gear 35. The inverters 41 and 42 are configured to drive the motors MG1 and MG2. The motor ECU 40 performs drive control for the motors MG1 and MG2 by controlling the inverters 41 and 42. The battery 50 is configured as, for example, a lithium-ion secondary battery, and exchanges electric power with the motors MG1 and MG2 via the inverters 41 and 42. The battery ECU 52 manages the battery 50. The HVECU 70 controls the entire vehicle.

The engine 22 and a transmission case (not shown) in which the planetary gear 30 and the motors MG1 and MG2 are accommodated are arranged in the lateral direction of the vehicle (are transversely mounted). The engine 22 is mounted on a vehicle body 12 via the engine mount 14. The transmission case is suspended from the vehicle body 12 by a transmission mount (not shown). Each of the engine mount 14 and the transmission mount includes an elastic body such as rubber provided therein, and can absorb vibrations.

Although not shown in FIG. 1, the engine ECU 24 is configured as a microprocessor that is mainly constituted by a CPU. In addition to the CPU, the engine ECU 24 includes a ROM that stores a processing program, a RAM that temporarily stores data, input/output ports, and communication ports. The engine ECU 24 receives, via the input ports, signals from various sensors that detect an operation state of the engine 22, for example, a crank position Ocr from a crank position sensor that detects a rotational position of the crankshaft 26, a coolant temperature Tw from a coolant temperature sensor that detects a temperature of coolant of the engine 22, an in-cylinder pressure Pin from a pressure sensor that is installed in a combustion chamber, a cam position Oca from a cam position sensor that detects a rotational position of a camshaft that opens/closes an intake valve for sucking air into the combustion chamber or an exhaust valve for discharging exhaust gas from the combustion chamber, a throttle position TP from a throttle valve position sensor that detects a position of a throttle valve, an intake air amount Qa from an airflow meter that is attached to an intake pipe, an intake air temperature Ta from a temperature sensor that is also attached to the intake pipe, an air-fuel ratio AF from an air-fuel ratio sensor that is attached to an exhaust system, and an oxygen signal O2 from an oxygen sensor that is also attached to the exhaust system. The engine ECU 24 outputs, via the output ports, various control signals for driving the engine 22, for example, a drive signal to a fuel injection valve, a drive signal to a throttle motor that adjusts the position of the throttle valve, a control signal to an ignition coil that is integrated with an igniter, and a control signal to a variable valve timing mechanism that can change the timings for opening/closing the intake valve. Besides, the engine ECU 24 communicates with the HVECU 70, performs operation control for the engine 22 through a control signal from the HVECU 70, and outputs data on the operation state of the engine 22 to the HVECU 70 according to need. The engine ECU 24 also calculates a rotational speed of the crankshaft 26, namely, a rotational speed Ne of the engine 22 on the basis of a signal from the crank position sensor (not shown), which is attached to the crankshaft 26.

Although not shown in FIG. 1, the motor ECU 40 is configured as a microprocessor that is mainly constituted by a CPU. In addition to the CPU, the motor ECU 40 includes a ROM that stores a processing program, a RAM that temporarily stores data, input/output ports, and communication ports. The motor ECU 40 receives, via the input ports, signals needed to perform drive control for the motors MG1 and MG2, for example, rotational positions θm1 and θm2 from rotational position detection sensors 43 and 44 that detect rotational positions of the rotors of the motors MG1 and MG2 respectively, and phase currents that are detected by current sensors (not shown) and applied to the motors MG1 and MG2 respectively. The motor ECU 40 outputs, via the output ports, switching control signals to switching elements (not shown) of the inverters 41 and 42, and the like. Besides, the motor ECU 40 communicates with the HVECU 70, performs drive control for the motors MG1 and MG2 through a control signal from the HVECU 70, and outputs data on the operation states of the motors MG1 and MG2 to the HVECU 70 according to need. The motor ECU 40 also calculates turning angle velocities ωm1 and ωm2 and rotational speeds Nm1 and Nm2 of the motors MG1 and MG2 on the basis of rotational positions θm1 and θm2 of the rotors of the motors MG1 and MG2 from the rotational position detection sensors 43 and 44, respectively.

Although not shown in FIG. 1, the battery ECU 52 is configured as a microprocessor that is mainly constituted by a CPU. In addition to the CPU, the battery ECU 52 includes a ROM that stores a processing program, a RAM that temporarily stores data, input/output ports, and communication ports. The battery ECU 52 receives, via the input ports, signals needed to manage the battery 50, for example, an inter-terminal voltage Vb from a voltage sensor (not shown) that is installed between terminals of the battery 50, a charge/discharge current Ib from a current sensor (not shown) that is attached to an electric power line that is connected to an output terminal of the battery 50, a battery temperature Tb from a temperature sensor (not shown) that is attached to the battery 50. The battery ECU 52 transmits data on the state of the battery 50 to the HVECU 70 through communication according to need. Besides, in order to manage the battery 50, the battery ECU 52 calculates a state of charge SOC at the present time, that is, a ratio of the capacity of an electric power that can be discharged from the battery 50 to the entire capacity, on the basis of an integrated value of the charge/discharge current Ib detected by the current sensor, and calculates input/output limits Win and Wout as a maximum permissible electric power with which the battery 50 may be charged or which may be discharged from the battery 50, on the basis of the calculated state of charge SOC and the battery temperature Tb. The input/output limits Win and Wout of the battery 50 can be set by setting basic values of the input/output limits Win and Wout on the basis of the battery temperature Tb, setting an output limit correction coefficient and an input limit correction coefficient on the basis of the state of charge SOC of the battery 50, and multiplying the set basic values of the input/output limits Win and Wout by the correction coefficients respectively.

The HVECU 70 is configured as a microprocessor that is mainly constituted by a CPU 72. In addition to the CPU 72, the HVECU 70 includes a ROM 74 that stores a processing program, a RAM 76 that temporarily stores data, input/output ports, and communication ports. The HVECU 70 receives, via the input ports, an ignition signal from an ignition switch 80, a shift position SP from a shift position sensor 82 that detects an operation position of a shift lever 81, an accelerator operation amount Acc from an accelerator pedal position sensor 84 that detects a depression amount of an accelerator pedal 83, a brake pedal position BP from a brake pedal position sensor 86 that detects a depression amount of a brake pedal 85, and a vehicle speed V from a vehicle speed sensor 88. As described above, the HVECU 70 is connected to the engine ECU 24, the motor ECU 40, and the battery ECU 52 via the communication ports respectively, and exchanges various control signals and data with the engine ECU 24, the motor ECU 40, and the battery ECU 25. In the hybrid vehicle 20 according to the embodiment of the invention, examples of the position of the shift lever 81 that is detected by the shift position sensor 82 include a parking position (a P position), a neutral position (an N position), a drive position (a D position), and a reverse (an R position).

In the hybrid vehicle 20 according to the embodiment of the invention thus configured, a required torque Tr* that needs to be output to the ring gear shaft 32a as the drive shaft is calculated on the basis of the accelerator operation amount Acc corresponding to the depression amount of the accelerator pedal operated by the driver and the vehicle speed V. Operation control for the engine 22 and the motors MG1 and MG2 is performed such that a required power corresponding to this required torque Tr* is output to the ring gear shaft 32a. Operation control for the engine 22 and the motors MG1 and MG2 is performed in a torque conversion operation mode, a charge/discharge operation mode, a motor operation mode, or the like. In the torque conversion operation mode, operation control for the engine 22 is performed such that a power matching the required power is output from the engine 22, and drive control for the motors MG1 and MG2 is performed such that the entire power that is output from the engine 22 is subjected to torque conversion by the planetary gear 30 and the motors MG1 and MG2 and output to the ring gear shaft 32a. In the charge/discharge operation mode, operation control for the engine 22 is performed such that a power matching the sum of the required power and the electric power needed for the charge/discharge of the battery 50 is output from the engine 22, and drive control for the motor MG1 and the motor MG2 is performed such that the required power is output to the ring gear shaft 32a while the power that is output from the engine 22 along with the charge/discharge of the battery 50 is entirely or partially subjected to torque conversion by the planetary gear 30, the motor MG1, and the motor MG2. In the motor operation mode, the operation of the engine 22 is stopped, and operation control is performed such that a power matching the required power from the motor MG2 is output to the ring gear shaft 32a. Both the torque conversion operation mode and the charge/discharge operation mode are modes in which the engine 22, the motor MG1, and the motor MG2 are controlled such that the required power is output to the ring gear shaft 32a along with the operation of the engine 22, and there is no substantial difference in control therebetween. Therefore, both the operation modes will be comprehensively referred to hereinafter as an engine operation mode.

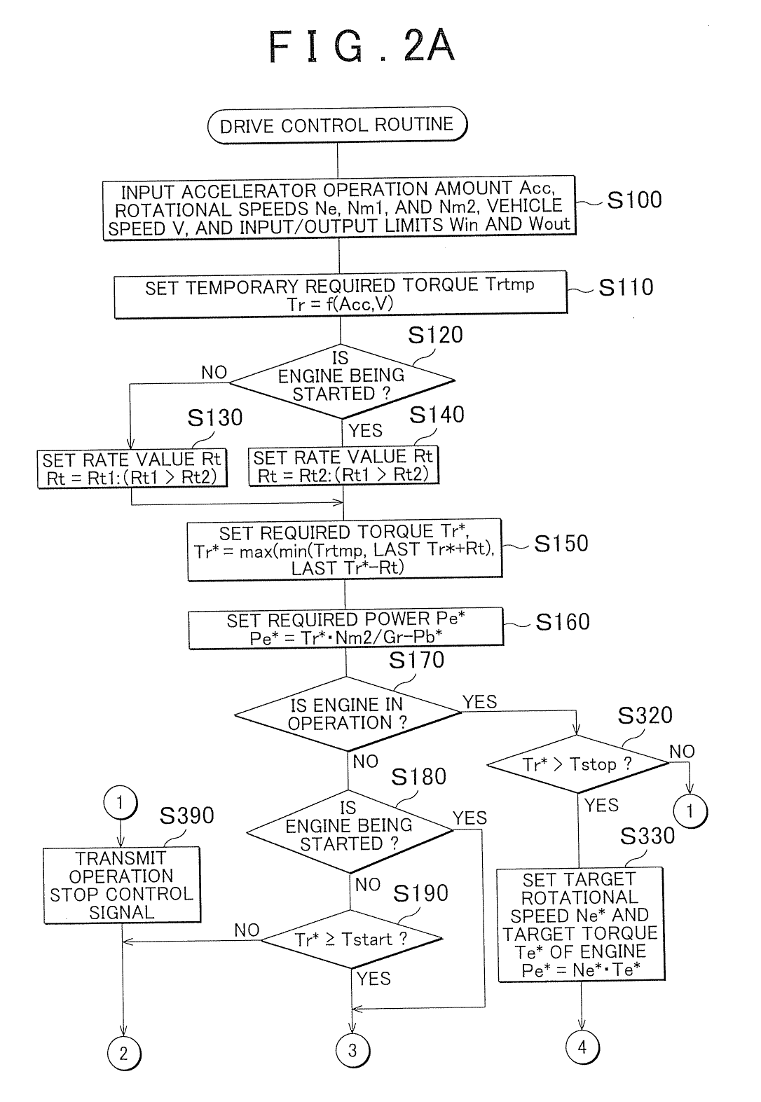

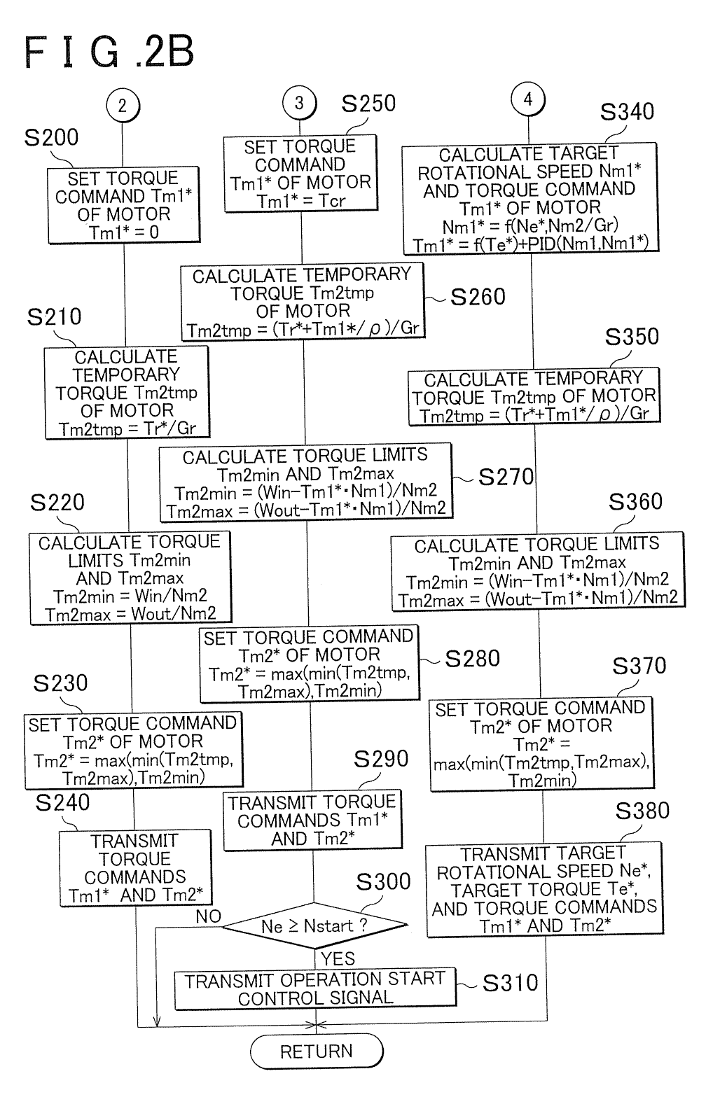

Next, the operation of the hybrid vehicle 20 according to the embodiment of the invention thus configured will be described. FIGS. 2A and 2B show a flowchart showing an example of a drive control routine that is executed by the HVECU 70 according to the embodiment of the invention. This routine is repeatedly executed at intervals of a predetermined time (e.g., at intervals of several milliseconds).

When the drive control routine is executed, the CPU 72 of the HVECU 70 first performs a process for inputting data needed to perform control, such as the accelerator operation amount Acc from the accelerator pedal position sensor 84, the vehicle speed V from the vehicle speed sensor 88, the rotational speed Ne of the engine 22, the rotational speeds Nm1 and Nm2 of the motors MG1 and MG2, the input/output limits Win and Wout of the battery 50, and the like (step S100). It should be noted herein that the rotational speed Ne of the engine 22 is input to the HVECU 70 from the engine ECU 24 through communication after being calculated on the basis of a signal from the crank position sensor (not shown). Besides, the rotational speeds Nm1 and Nm2 of the motors MG1 and MG2 are input to the HVECU 70 from the motor ECU 40 through communication after being calculated on the basis of the rotational positions θm1 and θm2 of the rotors of the motors MG1 and MG2, which are detected by the rotational position detection sensors 43 and 44 respectively. Furthermore, the input/output limits Win and Wout of the battery 50 are input to the HVECU 70 from the battery ECU 52 through communication after being set on the basis of the battery temperature Tb of the battery 50 and the state of charge SOC of the battery 50.

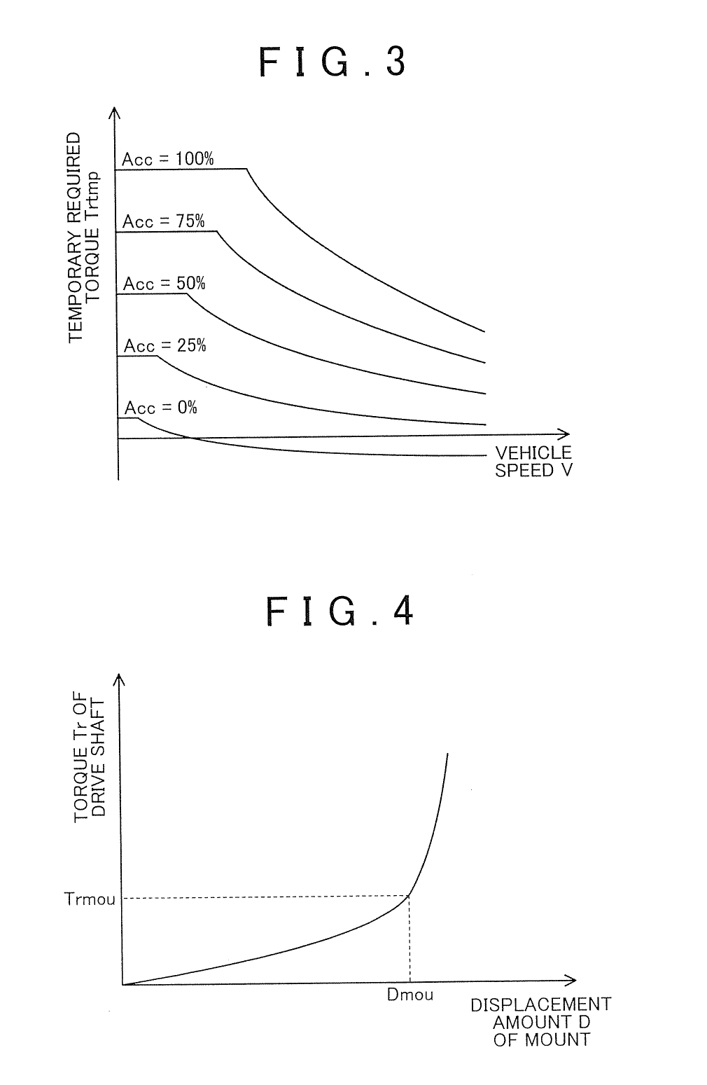

When the data are thus input, a temporary required torque Trtmp as a temporary value of the required torque Tr* that is required for traveling (i.e., that is to be output to the ring gear shaft 32a as the drive shaft) is set on the basis of the input accelerator operation amount Acc and the input vehicle speed V (step S110). It should be noted herein that the required torque Tr* is set by determining a relationship among the accelerator operation amount Acc, the vehicle speed V, and the temporary required torque Trtmp in advance, storing the relationship into the ROM 74 as a temporary required torque setting map, and deriving the corresponding temporary required torque Trtmp from the stored map when the accelerator operation amount Acc and the vehicle speed V are given, in the embodiment of the invention. FIG. 3 shows an example of the required torque setting map.

Subsequently, it is determined whether or not the engine 22 is being started (step S120). If the engine 22 is not being started, a predetermined value Rt1 is set as the rate value Rt that is used for a rate process (step S130). If the engine 22 is being started, a predetermined value Rt2 that is smaller than the predetermined value Rt1 is set as the rate value Rt (step S140). Then, as indicated by an expression (1) shown below, the temporary required torque Trtmp is subjected to the rate process using the rate value Rt to set the required torque Tr* (step S150). Due to this process, when the engine 22 is being started, the required torque Tr* more slowly (more gently) changes than when the engine 22 is not being started. The reason for more slowly changing the required torque Tr* when the engine 22 is being started than when the engine 22 is not being started will be described later.

Tr*=max(min(Trtmp,last Tr*+Rt),last Tr*−Rt) (1)

Then, a required power Pe* that is required of the vehicle is set by subtracting a charge/discharge required power Pb* with which the battery 50 is required to be charged or which is required to be discharged from the battery 50 (the charge/discharge required power Pb* is a positive value when electric power is required to be discharged from the battery 50) from a value that is obtained by multiplying the set required torque Tr* by the rotational speed Nr of the ring gear shaft 32a (e.g., a rotational speed that is obtained by dividing the rotational speed Nm2 of the motor MG2 by a gear ratio Gr of the reduction gear 35, a rotational speed that is obtained by multiplying the vehicle speed V by a conversion coefficient, or the like) (step S160).

Subsequently, it is determined whether the engine 22 is in operation or out of operation (step S170). If the engine 22 is out of operation, it is determined whether or not the engine 22 is being started (step S180). If the engine 22 is not being started, the required torque Tr* is compared with a start threshold value Tstart (step S190). It should be noted herein that the start threshold value Tstart is used to determine whether to start the engine 22 during the stop of the operation of the engine 22. In this embodiment of the invention, the start threshold value Tstart is a torque that is equal to or smaller than a rated corresponding torque Trrat (=Tm2rat·Gr), and smaller than a torque at which an elastic body (not shown) is compressed in the engine mount 14 (hereinafter the torque at which the elastic body is compressed in the engine mount 14 will be referred to as an elastic body compression torque Trmou). The rated corresponding torque Trrat is obtained by converting the rated maximum torque Tm2rat of the motor MG2 into a torque of the ring gear shaft 32a. This start threshold value Tstart will be described hereinafter.

FIG. 4 is an illustration diagram showing an example of a relationship between the torque applied to the ring gear shaft 32a as the drive shaft (hereinafter referred to as the drive shaft torque Tr) and the displacement amount D of the engine mount 14.

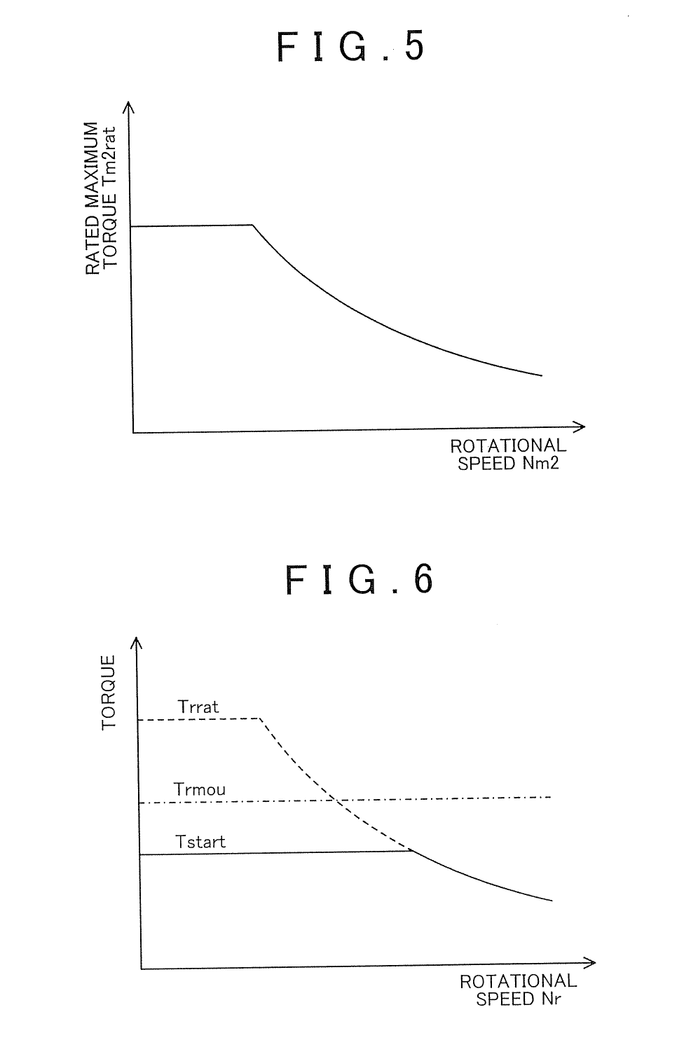

FIG. 5 is an illustration diagram showing an example of a relationship between the rotational speed Nm2 of the motor MG2 and the rated maximum torque Tm2rat. In FIG. 4, “Dmou” denotes the displacement amount D at which the elastic body is compressed in the engine mount 14 (hereinafter the displacement amount D at which the elastic body is compressed in the engine mount 14 will be referred to as an elastic body compression displacement amount). The aforementioned elastic body compression torque Trmou is the drive shaft torque Tr at which the displacement amount D of the engine mount 14 is equal to the elastic body compression displacement amount Dmou. As shown in FIG. 4, the displacement amount D of the engine mount 14 increases as the drive shaft torque Tr increases. In a region where the drive shaft torque Tr is larger than the elastic body compression torque Trmou, the degree of the increase in the displacement amount D of the engine mount 14 with respect to the increase in the drive shaft torque Tr is smaller than in a region where the drive shaft torque Tr is equal to or smaller than the elastic body compression torque Trmou. Besides, as shown in FIG. 5, the rated maximum torque Tm2rat of the motor MG2 generally tends to increase as the rotational speed Nm2 of the motor MG2 decreases. Accordingly, in the case where the rated corresponding torque Trrat is used as the start threshold value Tstart, when the rotational speed Nm2 of the motor MG2 (the rotational speed Nr of the ring gear shaft 32a) is low, the engine 22 may be started with the elastic body being compressed in the engine mount 14. In this case, for example, vibrations caused in starting the engine 22 are likely to be transmitted to the vehicle body 12, and as a result, the magnitude of a shock caused in starting the engine 22 may become great. In this view, in the embodiment of the invention, the start threshold value Tstart is set to a torque that is equal to or smaller than the rated corresponding torque Trrat (=Tm2max·Gr) and smaller than the elastic body compression torque Trmou. FIG. 6 is an illustration diagram showing an example of a relationship among the rated corresponding torque Trrat, the elastic body compression torque Trmou, and the start threshold value Tstart. As is apparent from FIG. 6, the start threshold value Tstart is set such that the start threshold value Tstart is equal to or smaller than the rated corresponding torque Trrat and the difference between the start threshold value Tstart and the rated corresponding torque Trrat tends to increase as the rotational speed Nr of the ring gear shaft 32a decreases.

In order to restrain a great shock from being caused in starting the engine 22, this start threshold value Tstart is preferably set smaller than a value that is assumed to prevent the required torque Tr* from becoming equal to the elastic body compression torque Trmou until the completion of the start of the engine 22, for example, a value (Trmou−ΔTr) that is obtained by subtracting an increase (an assumed value) ΔTr in the required torque Tr* during the start of the engine 22 from the elastic body compression torque Trmou. On the other hand, in order to keep the operation of the engine 22 stopped (to continuously cause the vehicle to travel in the motor operation mode) as long as possible, this start threshold value Tstart is preferably set to a relatively large value. In general, the required torque Tr* is considered to increase during the start of the engine 22 in many cases. However, in the embodiment of the invention, as described above, during the start of the engine 22, the required torque Tr* is set by subjecting the temporary required torque Trtmp to the rate process using the rate value Rt (=Rt2) that is smaller than the rate value Rt (=Rt1) at the time when the engine 22 is not being started (the required torque Tr* is more slowly changed than when the engine 22 is not being started). Therefore, the increase (the assumed value) ΔTr in the required torque Tr* during the start of the engine 22 is considered to be smaller than in the case where the required torque Tr* is set by subjecting the temporary required torque Trtmp to the rate process using the same rate value Rt (=Rt1) as when the engine 22 is not being started (the required torque Tr* is changed in the same manner as when the engine 22 is not being started). As a result, the start threshold value Tstart can be set to a larger value.

If the required torque Tr* is smaller than the start threshold value Tstart in step S190, it is determined that the operation of the engine 22 should continued to be stopped (i.e., the vehicle should be continuously caused to travel in the motor operation mode), the value 0 is set as the torque command Tm1* of the motor MG1 (step S200), the required torque Tr* is divided by the gear ratio Gr of the reduction gear 35 to be set as the temporary torque Tm2tmp as a temporary torque of the torque to be output from the motor MG2 (step S210), the input/output limits Win and Wout of the battery 50 are divided by the rotational speed Nm2 of the motor MG2 to calculate torque limits Tm2 min and Tm2max as lower and upper limits of the torque that may be output from the motor MG2 (step S220), and the temporary torque Tm2tmp is limited by the torque limits Tm2 min and Tm2max to set the torque command Tm2* of the motor MG2 as indicated by an expression (2) shown below (step S230).

Tm2*=max(min(Tm2tmp,Tm2max),Tm2 min) (2)

When the torque commands Tm1* and Tm2* of the motors MG1 and MG2 are thus set, the set torque commands Tm1* and Tm2* of the motors MG1 and MG2 are transmitted to the motor ECU 40 (step S240), and the present routine is ended. The motor ECU 40, which has received the torque commands Tm1* and Tm2*, performs switching control for the switching elements of the inverters 41 and 42 such that the motor MG1 is driven according to the torque command Tm1* and that the motor MG2 is driven according to the torque command Tm2*. Due to this control, the vehicle can travel with the engine 22 stopped, while the required torque Tr* is output to the ring gear shaft 32a as the drive shaft within the range defined by the input/output limits Win and Wout of the battery 50.

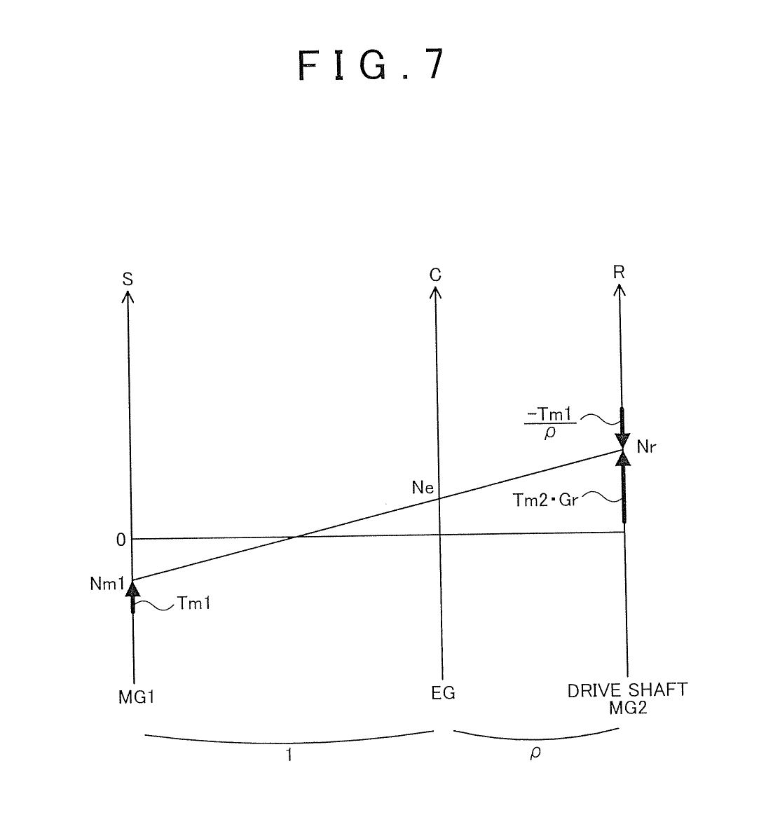

If the required torque Tr* is equal to or larger than the start threshold Tstart in step S190, it is determined that the engine 22 should be started, and a torque Tcr for cranking the engine 22 is set as the torque command Tm1* as a torque to be output from the motor MG1 (step S250). Subsequently, as indicated by an expression (3) shown below, a value that is obtained by dividing the torque command value Tm1* of the motor MG1 by a gear ratio p of the planetary gear 30 is added to the required torque Tr*, then the obtained value is divided by the gear ratio Gr of the reduction gear 35, and the obtained value is set as the temporary torque Tm2tmp as a temporary torque of the torque to be output from the motor MG2 (step S260). Subsequently, as indicated by expressions (4) and (5), a value that is obtained by subtracting an electric power consumption (a generated electric power) of the motor MG1, which is obtained by multiplying the torque command Tm1* of the motor MG1 by the current rotational speed Nm1 of the motor MG1, from the input/output limits Win and Wout of the battery 50 is divided by the rotational speed Nm2 of the motor MG2 to calculate the torque limits Tm2 min and Tm2max of the motor MG2 respectively (step S270). Subsequently, as indicated by the aforementioned expression (2), the temporary torque Tm2tmp is limited by the torque limits Tm2 min and Tm2max to set the torque command Tm2* of the motor MG2 (step S280), and the set torque commands Tm1* and Tm2* of the motors MG1 and MG2 are transmitted to the motor ECU 40 (step S290). FIG. 7 shows an example of a collinear diagram showing a mechanical relationship between rotational speed and torque in the rotating components of the planetary gear 30 when starting the engine 22. In FIG. 7, an S-axis on the left side represents the rotational speed of the sun gear 31 as the rotational speed Nm1 of the motor MG1, a C-axis represents the rotational speed of the carrier 34 as the rotational speed Ne of the engine 22, and an R-axis represents the rotational speed Nr of the ring gear 32, which is obtained by dividing the rotational speed Nm2 of the motor MG2 by the gear ratio Gr of the reduction gear 35. Two thick arrows on the R-axis represent the torque that is output from the motor MG1 and applied to the ring gear shaft 32a as the drive shaft, and the torque that is output from the motor MG2 and applied to the ring gear shaft 32a via the reduction gear 35. The expression (3) can be easily derived if this collinear diagram is used.

Tm2tmp=(Tr*+Tm1*/ρ)/Gr (3)

Tm2 min=(Win−Tm1ρNm1)/Nm2 (4)

Tm2max=(Wout−Tm1*·Nm1)/Nm2 (5)

It is then determined whether or not the rotational speed Ne of the engine 22 has become equal to or larger than a predetermined rotational speed Nstart at which fuel injection control and ignition control are started (e.g., 1000 rpm, 1200 rpm, or the like) (step S300). Since it is now assumed that the process of starting the engine 22 is started, the rotational speed Ne of the engine 22 has not become equal to the predetermined rotational speed Nstart. Accordingly, the present routine is immediately ended. In the embodiment of the invention, in order to stabilize the air-fuel ratio immediately after the start of the engine 22 and hence stabilize combustion, the engine 22 is cranked to be started with the throttle valve of the engine 22 closed.

If the process of starting the engine 22 is thus started, it is determined in step S180 that the engine 22 is being started, the torque commands Tm1* and Tm2* of the motors MG1 and MG2 are set and transmitted to the motor ECU 40 through the aforementioned processes of steps S250 to S290, and it is determined whether or not the rotational speed Ne of the engine 22 has become equal to or larger than the predetermined rotational speed Nstart (step S300). If the rotational speed Ne of the engine 22 has not become equal to the predetermined rotational speed Nstart, the present routine is immediately ended. If the rotational speed Ne of the engine 22 has become equal to or larger than the predetermined rotational speed Nstart, an operation start control signal is transmitted to the engine ECU 24 such that fuel injection control and ignition control for the engine 22 are started (step S310), and the present routine is ended. The engine ECU 24, which has received the operation start control signal, starts fuel injection control and ignition control for the engine 22. Due to this control, the vehicle can travel with the required torque Tr* output from the motor MG2 to the ring gear shaft 32a as the drive shaft within the range defined by the input/output limits Win and Wout of the battery 50, while the engine 22 is being started.

As described hitherto, in the embodiment of the invention, the engine 22 is started when the required torque Tr* becomes equal to or larger than the start threshold value Tstart, and the start threshold value Tstart is set to a torque that is equal to or smaller than the rated corresponding torque Trrat and smaller than the elastic body compression torque Trmou (i.e., the start threshold value Tstart is set to a torque that is equal to or smaller than the rated corresponding torque Trrat and the difference between the start threshold value Tstart and the rated corresponding torque Trrat tends to increase as the rotational speed Nr of the ring gear shaft 32a decreases). Therefore, a great shock can be restrained from being caused when the engine 22 is cranked to be started, in comparison with a case where the start threshold value Tstart is set to the rated corresponding torque Trrat.

If the start of the engine 22 is completed (i.e., the process of starting the engine 22 is completed), it is determined in step S170 that the engine 22 is in operation (the engine 22 is being operated), and the required torque Tr* is compared with a stop threshold value Tstop (step S320). It should be noted herein that the stop threshold value Tstop is used to determine whether or not the operation of the engine 22 should be stopped during the operation of the engine 22, and a value that is smaller than the start threshold value Tstart by a margin a (Tstart−α) is used as the stop threshold value Tstop in the embodiment of the invention. The margin α can be appropriately set in consideration of the fact that the engine mount 14 has a characteristic (a so-called hysteresis characteristic) in which the corresponding drive shaft torque Tr changes depending on whether the displacement amount D increases or decreases. By thus setting a difference between the start threshold value Tstart and the stop threshold value Tstop, it is possible to achieve an effect of restraining the engine 22 from being frequently started and stopped.

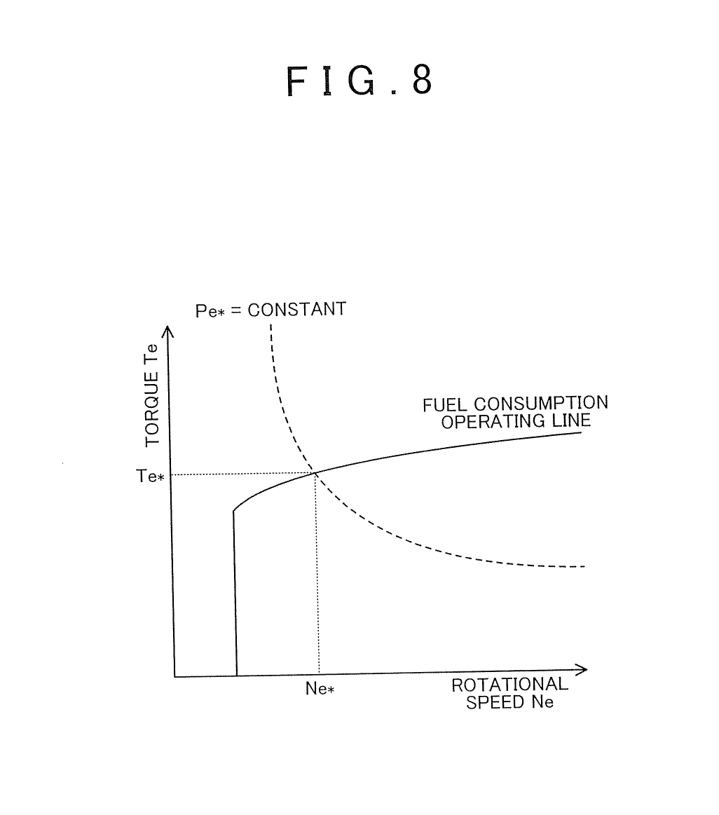

If the required torque Tr* is larger than the stop threshold Tstop, it is determined that the engine 22 should be held in operation (the operation of the engine 22 should be continued, the vehicle should be continuously caused to travel in the engine operation mode), and the target rotational speed Ne* and the target torque Te* as an operation point at which the engine 22 should be operated are set on the basis of the required power Pe* and an operating line for causing the engine 22 to operate efficiently (e.g., a fuel consumption operating line) (step S330). FIG. 8 shows an example of the operating line of the engine 22, and how the target rotational speed Ne* and the target torque Te* are set. As shown in FIG. 8, the target rotational speed Ne* and the target torque Te* can be obtained as an intersecting point of the operating line and a curve on which the required power Pe*(Ne*×Te*) is constant.

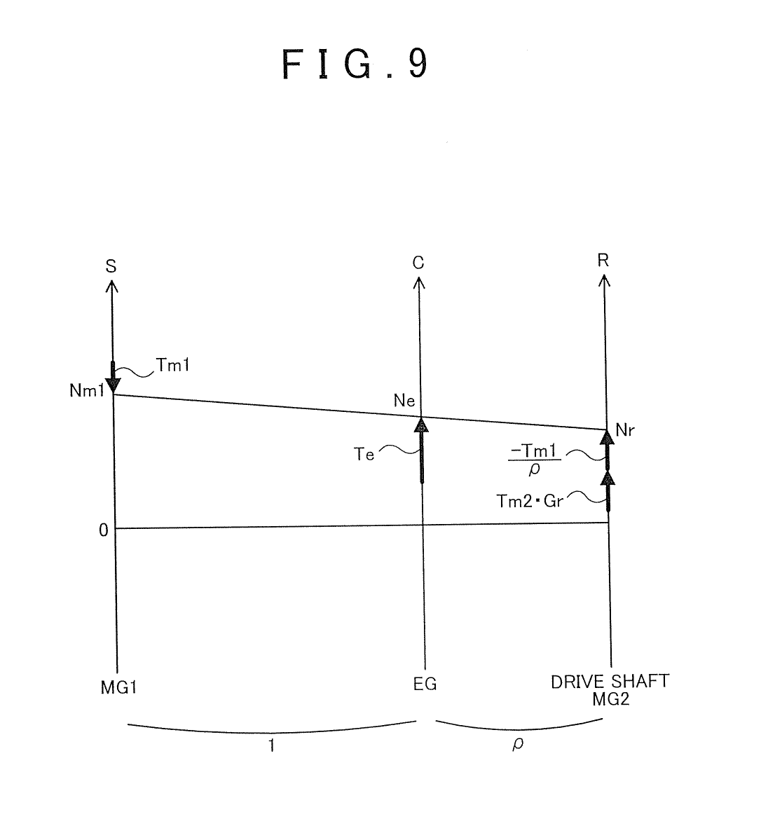

Subsequently, the target rotational speed Nm1* of the motor MG1 is calculated according to an expression (6) shown below, using the target rotational speed Ne* of the engine 22, the rotational speed Nm2 of the motor MG2, the gear ratio ρ of the planetary gear 30, and the gear ratio Gr of the reduction gear 35, and also, the torque command Tm1* of the motor MG1 is calculated according to an expression (7), using the calculated target rotational speed Nm1* of the motor MG1, the current rotational speed Nml, the target torque Te* of the engine 22, and the gear ratio ρ of the planetary gear 30 (step S340). It should be noted herein that the expression (6) is a mechanical relational expression for the rotating components of the planetary gear 30. FIG. 9 shows an example of a collinear diagram showing a mechanical relationship between rotational speed and torque in the rotating components of the planetary gear 30 at the time when the vehicle travels with power output from the engine 22. The expression (6) can be easily derived if this collinear diagram is used. Besides, the expression (7) is a relational expression in feedback control for rotating the motor MG1 at the target rotational speed Nm1*. In the expression (7), the second term “k1” on the right side is a gain of a proportional term, and the third term “k3” on the right side is a gain of an integral term.

Nm1*=Ne*·(1+ρ)/ρ−Nm2/(Gr·ρ) (6)

Tm1*=−ρ·Te*/(1+p)+k1(Nm1*−Nm1)+k2∫(Nm1*−Nm1)dt (7)

Then, in the same manner as in the aforementioned processes of steps S260 to S280, the torque command Tm2* of the motor MG2 is set according to the aforementioned expressions (3) to (5) (steps S350 to S370), the target rotational speed Ne* of the engine 22 and the target torque Te* of the engine 22 are transmitted to the engine ECU 24, and the torque commands Tm1* and Tm2* of the motors MG1 and MG2 are transmitted to the motor ECU 40 (step S380), and the present routine is ended. The engine ECU 24, which has received the target rotational speed Ne* of the engine 22 and the target torque Te* of the engine 22, performs control such as intake air amount control, fuel injection control, and ignition control in the engine 22 so that the engine 22 is operated at an operation point indicated by the target rotational speed Ne* and the target torque Te*.

Due to this control, the vehicle can travel with the required torque Tr* output to the ring gear shaft 32a as the drive shaft within the range defined by the input/output limits Win and Wout of the battery 50, while the engine 22 is in operation.

If the required torque Tr* is equal to or smaller than the stop threshold value Tstop in step S320, an operation stop control signal is transmitted to the engine ECU 24 so that fuel injection control and ignition control of the engine 22 are stopped (step S390), and the torque commands Tm1* and Tm2* of the motors MG1 and MG2 are set and transmitted to the motor ECU 40 through the aforementioned processes of steps S200 to S240, and the present routine is ended. The engine ECU 24, which has received the operation stop control signal, stops fuel injection control and ignition control for the engine 22. If the operation of the engine 22 is thus stopped, it is determined in step S170 that the engine 22 is out of operation, and the processes starting from step S180 are performed.

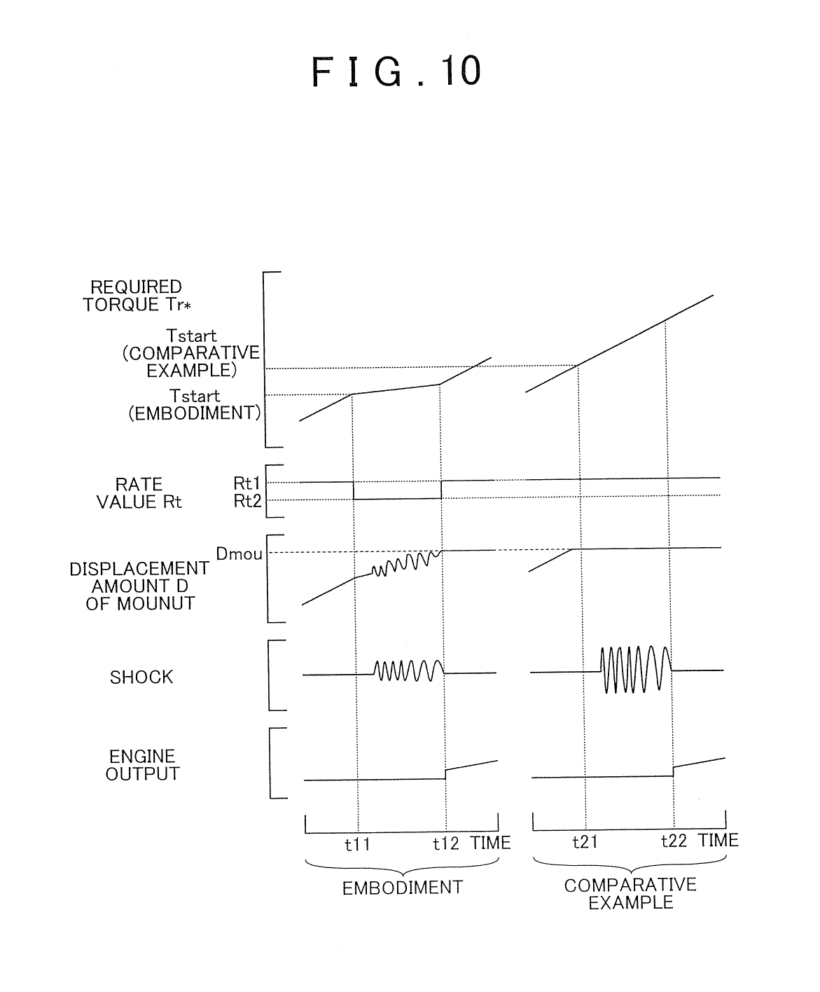

FIG. 10 is an illustration diagram showing an example of the manner in which the required torque Tr*, the rate value Rt, the displacement amount D of the engine mount 14, the shock, and the output of the engine 22 change with time in starting the engine 22 when the rotational speed Nr of the ring gear shaft 32a is relatively small (when the rated corresponding torque Trrat is relatively large). The left side of FIG. 10 shows the embodiment in which the start threshold value is set to a torque that is equal to or smaller than the rated corresponding torque Trrat and smaller than the elastic body compression torque Trmou (i.e., the start threshold value is set to a torque that is equal to or smaller than the rated corresponding torque Trrat and the difference between the start threshold value and the rated corresponding torque Trrat increases as the rotational speed Nr of the ring gear shaft 32a decreases). The right side of FIG. 10 shows a comparative example in which the start threshold value Tstart is set to the rated corresponding torque Trrat. Besides, in FIG. 10, the time at which the process of starting the engine 22 is started is denoted by “t11” and “t21”, and the time at which the process of starting the engine 22 is completed is denoted by “t12” and “t22”.

As shown on the right side of FIG. 10, in the comparative example, the engine 22 is started while the displacement amount D of the engine mount 14 is equal to the elastic body compression displacement amount Dmou (i.e., while the elastic body is compressed in the engine amount 14). Thus, vibrations caused in starting the engine 22 are likely to be transmitted to the vehicle body 12, and as a result, a relatively great shock is caused. On the other hand, as shown on the left side of FIG. 10, in the embodiment of the invention, the engine 22 is started before the displacement amount D of the engine amount 14 becomes equal to the elastic body compression displacement amount Dmou. Therefore, the occurrence of a great shock can be suppressed in starting the engine 22.

In the hybrid vehicle 20 of the embodiment of the invention described above, the engine 22 is started when the required torque Tr* becomes equal to or larger than the start threshold value Tstart, and the start threshold value Tstart is set to a torque that is equal to or smaller than the rated corresponding torque Trrat and smaller than the elastic body compression torque Trmou (i.e., the start threshold value Tstart is set to a torque that is equal to or smaller than the rated corresponding torque Trrat and the difference between the start threshold value Tstart and the rated corresponding torque Trrat increases as the rotational speed Nr of the ring gear shaft 32a decreases). Therefore, in comparison with a case where the start threshold value Tstart is set to the rated corresponding torque Trrat, a great shock can be restrained from being caused when the engine 22 is cranked to be started.

In the hybrid vehicle 20 according to the embodiment of the invention, as shown in FIG. 6, the start threshold value Tstart is set to a value corresponding to the rotational speed Nr of the ring gear shaft 32a as the drive shaft (the rotational speed Nm2 of the motor MG2). However, the start threshold value Tstart may be set to a value corresponding to the shift position SP, the traveling mode, the temperature of the engine mount 14, a road surface gradient, the acceleration of the vehicle, or the like as well as the rotational speed Nr of the ring gear shaft 32a. The details will be described hereinafter.

First of all, the reason why the start threshold value Tstart may be set to a value corresponding to the shift position SP will be described. The manner in which the engine mount 14 is displaced is considered to vary depending on the traveling direction (a forward direction or a backward direction) of the vehicle. For example, in a hardware configuration where the engine 22 and the transmission case in which the planetary gear 30 and the motors MG1 and MG2 are accommodated are arranged in the lateral direction of the vehicle (transversely mounted), and the engine 22 is mounted on the vehicle body 12 via the engine mount 14 on the front face in the vehicle (hereinafter referred to as a front mount) and the engine mount 14 on the rear face in the vehicle (hereinafter referred to as a rear mount), during acceleration while traveling forward, a backward driving reaction force is applied from the ring gear shaft 32a to the engine 22 via the planetary gear 30, so that the front mount is displaced upward, and that the rear mount is displaced downward. Besides, in this hardware configuration, during acceleration while traveling backward, a forward driving reaction force is applied from the ring gear shaft 32a to the engine 22 via the planetary gear 30, so that the front mount is displaced downward, and that the rear mount is displaced upward. Accordingly, the start threshold value Tstart can be set to a more appropriate value by setting the start threshold value Tstart to a value corresponding to the shift position SP in consideration of the structure, arrangement, and the like of the front mount and the rear mount.

Subsequently, the reason why the start threshold value Tstart may be set to a value corresponding to the traveling mode will be described. It should be noted herein that a normal traveling mode, an economy mode in which higher priority is given to fuel economy than in the normal traveling mode, an EV mode in which higher priority is given to traveling in the motor operation mode than in the normal traveling mode, a sport mode in which higher priority is given to acceleration than in the normal traveling mode, a power mode in which higher priority is given to torque (power) output than in the normal traveling mode, and the like are conceivable as the traveling mode. In the economy mode or the EV mode, with a view to making it easier to continue to travel in the motor operation mode than in the normal traveling mode, the start threshold value Tstart is set to a larger value than in the normal traveling mode. In the sport mode or the power mode, with a view to making it easier to start the engine 22 than in the normal traveling mode, the start threshold value Tstart is set to a value smaller than in the normal traveling mode. Thus, the start threshold Tstart can be set to a more appropriate value. The economy mode, the EV mode, the sport mode, the power mode, and the like can be set by a switch installed in the vicinity of a driver seat, or the like.

Furthermore, the reason why the start threshold Tstart may be set to a value corresponding to the temperature of the engine mount 14 will be described. It is considered that the displacement amount D of the engine mount 14 is likely to increase (the elastic body is likely to be compressed in the engine mount 14) as the temperature of the engine mount 14 (the temperature of the elastic body therein) rises. This is because the softness of the elastic body inside the engine mount 14 increases as the temperature of the engine mount 14 rises. Accordingly, the start threshold value Tstart can be set to a more appropriate value by setting the start threshold value Tstart such that the start threshold value Tstart decreases as the temperature of the engine mount 14 rises. The temperature of the engine mount 14 may be directly detected by a sensor, or may be estimated on the basis of the coolant temperature Tw of the engine 22.

In addition, the reason why the start threshold value Tstart may be set to a value corresponding to the road surface gradient will be described. It is considered that the displacement amount D of the engine mount 14 is likely to increase (i.e., the elastic body is likely to be compressed in the engine mount 14) as the road surface gradient of an upslope increases. This is because the force applied in the direction opposite to the traveling direction (hereinafter referred to as a counter-traveling direction) (i.e., the component force of a vehicle weight in the counter-traveling direction) increases as the road surface gradient of an upslope increases. Accordingly, the start threshold value Tstart can be set to a more appropriate value by setting the start threshold value Tstart such that the start threshold value Tstart decreases as the road surface gradient of an upslope increases.

Besides, the reason why the start threshold value Tstart may be set to a value corresponding to the acceleration of the vehicle will be described. It is considered that the displacement amount D of the engine mount 14 is likely to increase (the elastic body is likely to be compressed in the engine mount 14) as the acceleration of the vehicle increases. Accordingly, the start threshold value Tstart can be set to a more appropriate value by setting the start threshold value Tstart such that the start threshold value Tstart decreases as the acceleration of the vehicle increases. It has been found out through experiments, analyses, or the like that the acceleration of the vehicle has a smaller influence on the displacement amount D of the engine mount 14 than the shift position SP, the temperature of the engine mount 14, and the road surface gradient.

In the hybrid vehicle 20 according to the embodiment of the invention, when the required torque Tr* becomes equal to or larger than the start threshold value Tstart, the engine 22 is started. Namely, a torque start condition that the required torque Tr* is equal to or larger than the start threshold value Tstart is used as a condition for starting the engine 22. However, a power start condition that the required power Pe* is equal to or larger than a start threshold value Pstart, a state-of-charge start condition that the state of charge SOC of the battery 50 is equal to or smaller than a start threshold value Sstart, and the like as well as the torque start condition may be used as the condition for starting the engine 22. If all the conditions are unfulfilled, the operation of the engine 22 may continue to be stopped (the vehicle may be continuously caused to travel in the motor operation mode). If at least one of the conditions is fulfilled, the engine 22 may be started. Besides, in the hybrid vehicle 20 according to the embodiment of the invention, when the required torque Tr* becomes equal to or smaller than the stop threshold value Tstop, the operation of the engine 22 is stopped. Namely, a torque stop condition that the required torque Tr* is equal to or smaller than the stop threshold value Tstop is used as a condition for stopping the engine 22. However, a power stop condition that the required power Pe* is equal to or smaller than a stop threshold value Pstop that is smaller than the start threshold value Pstart, a state-of-charge stop condition that the state of charge SOC of the battery 50 is equal to or larger than a stop threshold value Sstop that is larger than the start threshold value Sstart, and the like as well as the torque stop condition may be used as a condition for stopping the engine 22. If at least one of the conditions is unfulfilled, the engine 22 may continue to be operated (the vehicle may be continuously caused to travel in the engine operation mode). If all the conditions are fulfilled, the operation of the engine 22 may be stopped.

In the hybrid vehicle 20 according to the embodiment of the invention, when the engine 22 is being started, the required torque Tr* is set by subjecting the temporary required torque Trtmp to the rate process using the rate value Rt (=Rt2) that is smaller than the rate value Rt (=Rt1) used at the time when the engine 22 is not being started (the required torque Tr* is more slowly changed than when the engine 22 is not being started). However, the required torque Tr* may be set by subjecting the temporary required torque Trtmp to a rate process using the same rate value Rt (=Rt1) as when the engine 22 is not being started (the required torque Tr* may be changed in the same manner as when the engine 22 is not being started). In this case, the increase (the assumed value) ΔTr in the required torque Tr* during the start of the engine 22 is considered to be larger than in the embodiment of the invention. Therefore, the start threshold value Tstart needs to be set smaller than in the embodiment of the invention.

In the hybrid vehicle 20 according to the embodiment of the invention, in starting the engine 22, in order to stabilize the air-fuel ratio immediately after the start of the engine 22 thereby stabilizing combustion, the engine 22 is cranked to be started with the throttle valve of the engine 22 closed. However, in order to give priority to the responsiveness immediately after the start of the engine 22, the engine 22 may be cranked to be started with the throttle valve of the engine 22 open.

In the hybrid vehicle 20 according to the embodiment of the invention, the motor MG2 is connected to the ring gear shaft 32a as the drive shaft via the reduction gear 35. However, the motor MG2 may be connected to the ring gear shaft 32a via a transmission having two shift speeds, three shift speeds, four shift speeds, or the like instead of the reduction gear 35. Besides, the motor MG2 may be directly connected to the ring gear shaft 32a without the intermediary of the reduction gear 35, the transmission, or the like. In this case, the rated maximum torque Tm2rat of the motor MG2 is equal to the rated maximum torque Trrat of the ring gear shaft 32a.

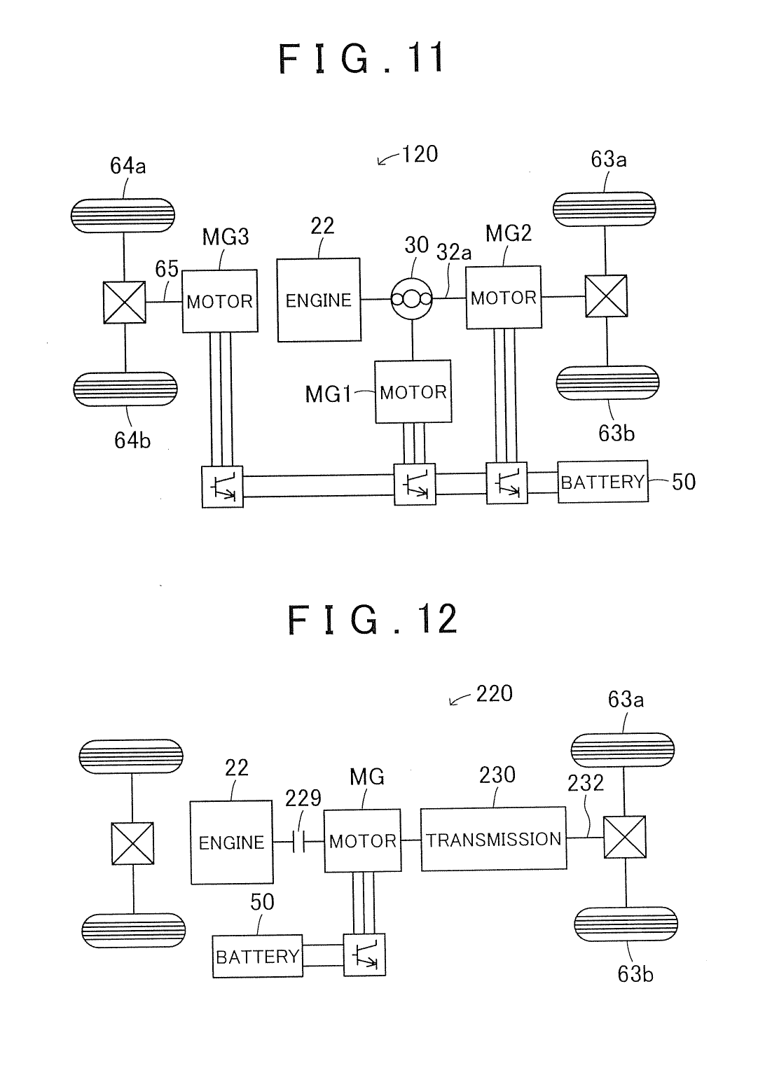

In the hybrid vehicle 20 according to the embodiment of the invention, the power from the engine 22 is output to the ring gear shaft 32a as the drive shaft that is connected to the driving wheels 63a and 63b via the planetary gear 30, and the power from the motor MG2 is output to the ring gear shaft 32a. However, as exemplified by a hybrid vehicle 120 according to a modification example of FIG. 11, in addition to the hard configuration of the hybrid vehicle 20 according to the embodiment of the invention, there may be provided a motor MG3 that receives/outputs power from/to a second drive shaft 65 and exchanges electric power with the battery 50. The second drive shaft 65 is coupled to an axle (an axle that is connected to wheels 64a and 64b in FIG. 11) that is different from an axle (an axle that is connected to the driving wheels 63a and 63b) to which the ring gear shaft 32a as the drive shaft is connected. In this case, as is the case with the embodiment of the invention, the start threshold value Tstart may be set to a torque that is equal to or smaller than the rated corresponding torque Trrat (=Tm2rat·Gr), which is obtained by converting the rated maximum torque Tm2rat of the motor MG2 into a torque of the ring gear shaft 32a, and is smaller than the elastic body compression torque Trmou at which the elastic body is compressed in the engine mount 14. This is because the torque that is output from the motor MG3 to the second drive shaft 65 is considered to have a sufficiently smaller influence on the displacement of the engine mount 14 than the torque that is output from the motor MG2 to the ring gear shaft 32a as the drive shaft.

In the hybrid vehicle 20 according to the embodiment of the invention, the power from the engine 22 is output to the ring gear shaft 32a as the drive shaft that is connected to the driving wheels 63a and 63b via the planetary gear 30, and the power from the motor MG2 is output to the ring gear shaft 32a. However, as exemplified by a hybrid vehicle 220 according to another modification example of FIG. 12, the configuration may be such that a motor MG is connected to a drive shaft 232, which is connected to the driving wheels 63a and 63b, via a transmission 230, and the engine 22 is connected to a rotation shaft of the motor MG via a clutch 229. The power from the engine 22 may be output to the drive shaft 232 via the rotation shaft of the motor MG and the transmission 230, and the power from the motor MG may be output to the drive shaft 232 via the transmission 230.

In the embodiment of the invention, the engine 22 may be regarded as “the engine”, the motor MG2 may be regarded as “the motor”, and the battery 50 may be regarded as “the battery”. The HVECU 70 that executes the drive control routine shown in FIGS. 2A and 2B, the engine ECU 24 that receives an operation start control signal from the HVECU 70 to start fuel injection control and ignition control for the engine 22, receives the target rotational speed Ne* and target torque Te* of the engine 22 from the HVECU 70 to perform intake air amount control, fuel injection control, ignition control, and the like for the engine 22, and receives an operation stop control signal from the HVECU 70 to stop fuel injection control and ignition control for the engine 22, and the motor ECU 40 that receives the torque commands Tm1* and Tm2* of the motors MG1 and MG2 from the HVECU 70 to control the motors MG1 and MG2 may be regarded as “the control unit”.

It should be noted herein that “the engine” is not limited to the engine 22 that outputs power using gasoline, light oil, or the like as fuel. Any type of engine that outputs power to a drive shaft coupled to an axle, such as a hydrogen engine or the like, may be employed. “The motor” is not limited to the motor MG2 that is configured as a synchronous generator motor. Any motor that outputs power to a drive shaft, such as an induction motor or the like, may be employed. “The battery” is not limited to the battery 50 that is configured as a lithium-ion secondary battery. Any type of battery that supplies electric power to a motor, such as a nickel hydride secondary battery, a nickel cadmium secondary battery, a lead storage battery or the like, may be employed. “The control unit” is not limited to the combination of the HVECU 70, the engine ECU 24, and the motor ECU 40, but may be constituted by a single electronic control unit or the like. Besides, “the control unit” is not limited to the control unit that starts the engine 22 when the required torque Tr* becomes equal to or larger than the start threshold value Tstart, and sets the start threshold value Tstart to a torque that is equal to or smaller than the rated corresponding torque Trrat, which is obtained by converting the rated maximum torque of the motor into the torque of the drive shaft, and is smaller than the elastic body compression torque Trmou at which the elastic body is compressed in the engine mount (i.e., sets the start threshold value Tstart such that the start threshold value Tstart is equal to or smaller than the rated corresponding torque Trrat and the difference between the start threshold value Tstart and the rated corresponding torque Trrat increases as the rotational speed Nr of the drive shaft decreases). Any control unit may be employed as long as the control unit starts an engine when a torque of a drive shaft becomes equal to or larger than a start threshold value while a vehicle travels with the engine stopped, and sets the start threshold value such that the start threshold value is equal to or smaller than a rated corresponding torque and the difference between the start threshold value and the rated corresponding torque increases as the rotational speed of the drive shaft decreases, the rated corresponding torque being a torque of the drive shaft corresponding to a rated maximum torque of a motor.

Although the mode for carrying out the invention has been described using the embodiment thereof, the invention is not limited to this embodiment thereof. The invention can be carried out in various forms without departing from the scope of the invention.

The invention may be used in hybrid vehicle manufacturing industries, and the like.

What is claimed is:

1. A hybrid vehicle comprising:
an engine that is mounted on a vehicle body via an engine mount, and outputs power to a drive shaft that is coupled to an axle;
a motor that outputs power to the drive shaft;
a battery that supplies electric power to the motor; and
a control unit configured to start the engine when a torque of the drive shaft becomes equal to or larger than a start threshold value while the vehicle travels with the engine stopped, the start threshold value being set such that the start threshold value is equal to or smaller than a rated corresponding torque and a difference between the start threshold value and the rated corresponding torque tends to increase as a rotational speed of the drive shaft decreases, and the rated corresponding torque being a torque of the drive shaft corresponding to a rated maximum torque of the motor.

2. The hybrid vehicle according to claim 1, wherein the start threshold value is set such that the engine is started with a displacement amount of the engine mount being smaller than a predetermined displacement amount.

3. The hybrid vehicle according to claim 1, wherein the start threshold value is set in accordance with at least one of a shift position, a traveling mode, a temperature of the engine mount, a road surface gradient, and an acceleration.

4. The hybrid vehicle according to claim 1, further comprising an electric generator that exchanges electric power with the battery, and a planetary gear that has three rotating components connected to the drive shaft, an output shaft of the engine, and a rotation shaft of the electric generator.

5. The hybrid vehicle according to claim 1, further comprising a second motor that exchanges electric power with the battery, and that outputs power to a second drive shaft coupled to a second axle that is different from the axle, the start threshold value being set without taking a torque of the second drive shaft into account.
